(19) United States
(12) Patent Application Publication
(10) Pub. No.: US 2021/0352173 A1
(43) Pub. Date: Nov. 11, 2021

(54) CONTROL OPERATING METHOD AND ELECTRONIC APPARATUS

(71) Applicant: ZTE CORPORATION, Shenzhen, Guangdong (CN)

(72) Inventors: Zaijun YANG, Shenzhen, Guangdong (CN); Yong ZHU, Shenzhen, Guangdong (CN); Changdong JIANG, Shenzhen, Guangdong (CN)

(21) Appl. No.: 17/277,728

(22) PCT Filed: Oct. 15, 2019
(86) PCT No.: PCT/CN2019/111340

§ 371 Date: Mar. 18, 2021

(30) Foreign Application Priority Data
Nov. 27, 2018 (CN) 201811426955.8

(51) Int. Cl. H04M 1/72469; H04M 1/72454; G06F 3/0482; G06F 3/0484

(52) U.S. Cl. CPC H04M 1/72469; H04M 1/72454; H04M 2201/42; G06F 3/04847; G06F 3/0482

(57) ABSTRACT

The present disclosure provides a control operating method and an electronic apparatus. The method includes: multiple menu items are exposed around a menu control when a click operation on the menu control is detected (S102); and when a click operation and/or a sliding operation on the menu control are/is detected again, switching among the exposed multiple menu items is carried out when a click operation and/or a sliding operation on the menu control are/is detected again (S104).

### CROSS REFERENCE TO RELATED APPLICATIONS

The present application claims priority to Chinese patent application No. 201811426955.8, entitled “CONTROL OPERATING METHOD AND ELECTRONIC APPARATUS,” filed Nov. 27, 2018, which is incorporated by reference herein in its entirety.

### TECHNICAL FIELD

The present disclosure relates to the field of communication technology, in particular, to a control operating method and electronic apparatus.

### BACKGROUND

When a user uses a smart phone, functional menu selection or mode switching is generally performed by touching functional buttons on a display screen. For example, after the user clicks a button on a mobile phone interface, a corresponding option box will pop up for the user to choose from various options. After the user selects one option, the interface returns and executes a function of the option (for example, switching mode or changing navigation, etc.), or directly displays all the options on the mobile phone interface, and the user choose one option to execute the corresponding function of the option.

However, an existing button operation method requires a click operation in different regions, so operation efficiency is relatively low. In addition, displaying of all options on the mobile phone interface takes up a lot of interface space, and because there is no clear operation prompt and the like, the operation is not intuitive.

### SUMMARY

The present disclosure provides a control operating method and an electronic device to at least solve the problem of low efficiency of control operation in related art.

According to certain embodiments of the present disclosure, a control operation method is provided, including: displaying in an expanding manner, around a menu control, multiple menu items corresponding to the menu control in response to a click operation on the menu control on a display screen; and switching among the multiple menu items displayed in the expanding manner in response to one or both of a click operation and a sliding operation on the menu control again.

Herein, the method further includes: selecting a menu item latest switched to, in response to one of: not detecting an operation on the menu control within a predetermined time period, and detecting a determination operation on the menu control.

Herein, the displaying in the expanding manner, around the menu control, multiple menu items includes one of the following: displaying in the expanding manner, around a position of the menu control, the multiple menu items horizontally or longitudinally, wherein one of the multiple menu items is displayed at the position of the menu control; displaying in the expanding manner horizontally or longitudinally the multiple menu items within a predetermined region spaced from the position of the menu control; and displaying in the expanding manner the multiple menu items around the menu control, wherein a region of the multiple menu items forms a regular or irregular shape.

Herein, switching among the multiple menu items displayed in the expanding manner when one or both of a click operation and a sliding operation on the menu control again includes one of the following: switching to a next menu item each time a click on the menu control is detected; continuously switching among the multiple menu items at a switching frequency corresponding to one or both of a click strength and a click time duration of a click on the menu control; continuously switching among the multiple menu items in response to a first click on the menu control, and stopping continuously switching in response to a second click on the menu control; and continuously switching among the multiple menu items at a switching frequency corresponding to a sliding strength and in a switching direction corresponding to a sliding direction, in response to a sliding operation on the menu control.

According to certain embodiments of the present disclosure, an electronic device is provided. In addition to including a display screen, the electronic device may further include: a first executing component configured to display in an expanding manner, around a menu control, multiple menu items corresponding to the menu control in response to a click operation on the menu control on a display screen; and a second executing component configured to switch among the multiple menu items displayed in the expanding manner in response to one or both of a click operation and a sliding operation again.

Herein, the electronic device further includes: a third executing component configured to select a menu item latest switched to, in response to one of: not detecting an operation on the menu control is not detected within a predetermined time period, and detecting a determination operation on the menu control.

Herein, the first executing component displays multiple menu items of the menu in the expanding manner in one of the following manners: displaying in the expanding manner, around a position of the menu control, the multiple menu items horizontally or longitudinally, wherein one of the multiple menu items is displayed at the position of the menu control; displaying in the expanding manner horizontally or longitudinally the multiple menu items within a predetermined region spaced from the position of the menu control; and displaying in the expanding manner the multiple menu items around the menu control, wherein a region of the multiple menu items forms a regular or irregular shape.

Herein, the second executing component is configured to switch among the multiple menu items in one of the following manners: switching to a next menu item each time a click on the menu control is detected; continuously switching among the multiple menu items at a switching frequency corresponding to one or both of a click strength and a click time duration of a click on the menu control; continuously switching among the multiple menu items in response to a first click on the menu control, and stopping continuously switching in response to a second click on the menu control; and continuously switching among the multiple menu items at a switching frequency corresponding to a sliding strength and in a switching direction corresponding to a sliding direction, in response to a sliding operation on the menu control.

According to certain embodiments of the present disclosure, a storage medium is provided. The storage medium stores a computer program arranged to implement the method according the above embodiments when the computer program is being executed.

According to certain embodiments of the present disclosure, an electronic device is provided. The electronic device includes a storage and a processor. The storage stores a computer program, and the processor is arranged to execute the above computer program to execute the method according to the above embodiments.

### BRIEF DESCRIPTION OF THE DRAWINGS

Drawings described herein provide a further understanding on the present disclosure, forming a part of the present disclosure. Exemplary embodiments and description in the present disclosure are for explaining the present disclosure and do not constitute a limitation to the present disclosure.

FIG. 1 is a flowchart of a button operation method according to certain embodiments of the present disclosure.

FIG. 2 is a schematic diagram showing a state change in menu items according to certain embodiments of the present disclosure.

FIG. 3 is a schematic diagram showing a switching mode change according to certain embodiments of the present disclosure.

FIG. 4 is a schematic diagram showing a switching mode change according to certain embodiments of the present disclosure.

FIG. 5 is a schematic diagram showing a switching mode change according to certain embodiments of the present disclosure.

FIG. 6 is a schematic diagram showing a switching mode change according to certain embodiments of the present disclosure.

FIG. 7 is a schematic diagram showing a switching mode change according to Embodiment 4 of the present disclosure.

FIG. 8 is a schematic diagram showing a prompt of a number of clicks according to Embodiment 5 of the present disclosure.

FIG. 9 is a schematic diagram showing a switching mode change according to Embodiment 6 of the present disclosure.

FIG. 10 is a schematic diagram showing a switching direction according to Embodiment 7 of the present disclosure.

FIG. 11 is a schematic diagram showing expansion of menu items according to Embodiment 8 of the present disclosure.

FIG. 12 is a schematic diagram showing menu traversal according to certain embodiments of the present disclosure.

FIG. 13 is a schematic diagram showing switching of desk-top applications according to certain embodiments of the present disclosure.

FIG. 14 is a schematic diagram showing switching of a camera mode according to certain embodiments of the present disclosure.

FIG. 15 is a schematic diagram showing an electronic device structure according to certain embodiments of the present disclosure.

### DETAILED DESCRIPTION

The present application will be described in detail in embodiments with reference to the drawings. It is to be noted that the embodiments and features in the embodiments in the present disclosure may be combined to derive other embodiments not explicitly described.

It is to be noted that such terms as “first” and “second” in the specification, Claims and the drawings of the present disclosure mean to distinguish similar objects rather than to describe a particular order or sequence.

An embodiment of the present disclosure provides a control operation method. FIG. 1 is a flowchart of a button operation method according to an embodiment of the present disclosure. As shown in FIG. 1, the flowchart may include the following steps.

In step S102, multiple menu items are exposed around a menu control when a click operation on the menu control on a display screen is detected.

In one embodiment, the menu control displayed on the display screen may be a randomly applicable control icon, for example, an icon button or a text button, having a plurality of items. The multiple menu items may be expanded at the original position of a clicked button (i.e., an original button is displayed as one menu item thereof) or may be expanded around the clicked button in a regular or irregular shape. For example, the multiple menu items are expanded around the clicked button in a horizontal or longitudinal direction, or in a shape such as a ring or a circle. In certain embodiments, the multiple menu items as displayed may be a menu of a same grade as that of the menu control. For example, the menu control corresponds to one navigation mode. When the menu control is clicked, all navigation modes are displayed in the expanding manner. In some embodiments, the multiple menu items displayed in the expanding manner may be sub-menus of the menu control. For example, the menu control corresponds to a film icon. When the menu control is clicked, all film modes are displayed in the expanding manner.

In step S104, switching among the exposed multiple menu items is carried out when a click operation and/or a sliding operation on the menu control are/is detected again. In this step, a user needs only to perform a further operation based on an original menu control, for example, to click or to slide to realize switching among expanded menu items rather than performing clicking or sliding in a plurality of regions, thereby operation efficiency is improved.

It shall be noted that after step S104, the control operation method may further include: selecting a menu item latest switched to, if an operation on the menu control is not detected within a predetermined time period, or if a determination operation on the menu control is detected. In certain embodiments, there may be a plurality of manners of determination operation on the menu control. For example, the determination operation may be a click operation in a blank region beside the menu control, or a click operation on a fixed entity or a virtual determination button. In addition, “selecting” in certain embodiments may be understood as executing a corresponding instruction of the menu item, for example, displaying an interface corresponding to the menu item, or switching to a mode corresponding to the menu item, or performing a function corresponding to the menu item and the like.

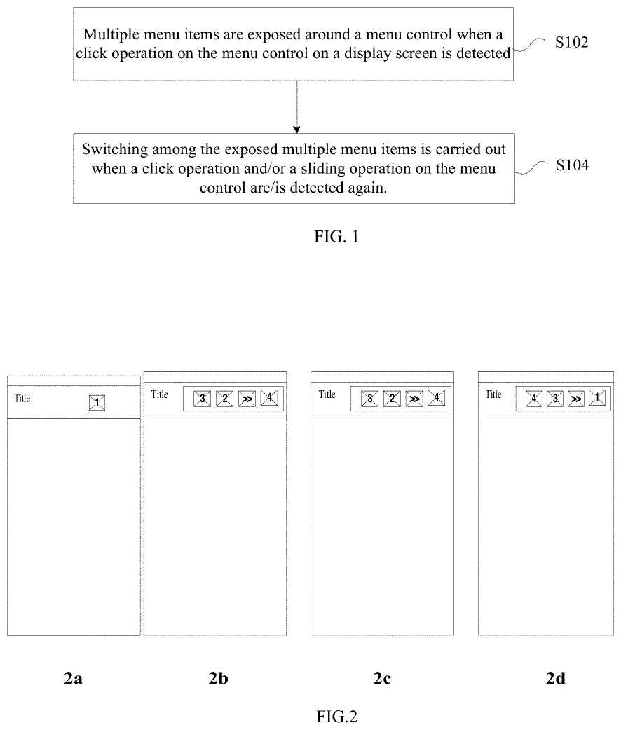

In the following, this embodiment will be described in detail from a user's point of view. As shown in FIG. 2, the icon buttons have four states which are, in order, an initial state (FIG. 2a), an expanding state (FIG. 2b), a switching state (FIG. 2c) and an ending state (FIG. 2d).

At the initial state in FIG. 2a, the icon button is not distinguished from a common button (which is not limited to a form of the icon button, and is applicable to a text button or another button). After the user clicks the icon button, the expanding state is displayed as shown in FIG. 2b. An entire expanded sub-menu group includes four items. The user may switch among the four items to execute a corresponding instruction (i.e., the user may perform mode switching, navigation switching or other operations). Herein, four items are clearly shown. If the user continues to click anyone of the buttons, any option may be selected and switched to (FIG. 2c), and a final result is shown in FIG. 2d.

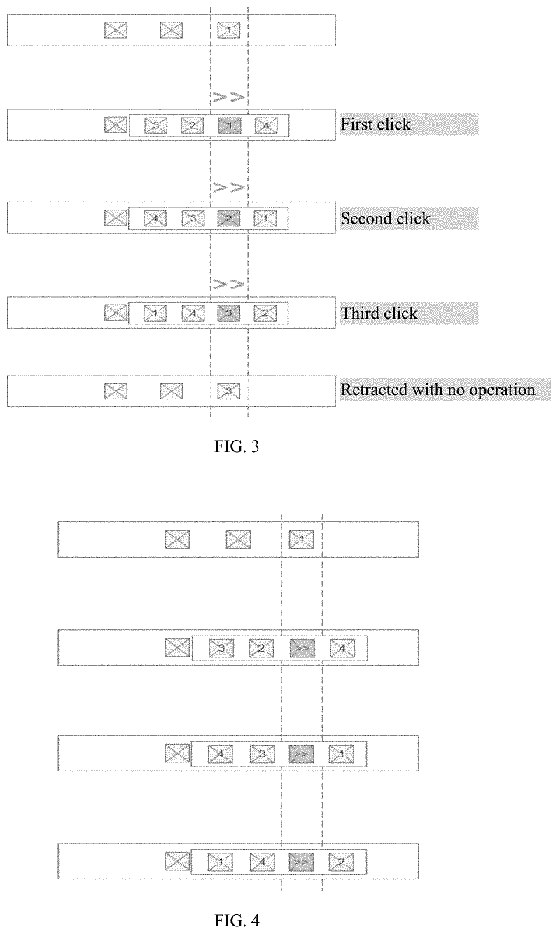

In certain embodiments, the four items in FIG. 2b are expanded from an original position of the icon button. That is, after being expanded, menu item 1 (i.e., the menu item shown with a direction in FIG. 2b) is in the same position as the clicked icon button (menu item 1 as shown in FIG. 2a) in FIG. 2a. When the user continuously clicks in the menu items, the four states as shown in FIGS. 2a to 2d may be switched continuously. For example, menu buttons with continuous changing are displayed as menu item 1 to menu item 4. As a click operation on a menu button may be continuously and periodically displayed, in a case where there is no operation, a mode in which a button latest clicked may be automatically switched to. An entire switching process is shown in FIG. 3. After a button icon is clicked for the first time, the four items are transversely expanded from the original position of the button icon. After the button icon is clicked for a second time, it is switched from the option 1 to option 2. After the button icon is clicked for a third time, it is switched from the option 2 to option 3. Within a predetermined time period, if the user does not click the button again, the latest switched option 3 is selected, and the state of four items expanded is recovered to the initial state. In certain embodiments, the initial state refers to a layout and display positions of the menu buttons before the menu items are expanded. For example, after the menu items are retracted, the display positions of the menu buttons and a number of displayed menu buttons are the same as those before the menu items are expanded, but menu items corresponding to the menu buttons may be the same or different from those before the menu items are expanded.

This embodiment may be compatible with an existing button-clicking manner, i.e., after the buttons are clicked to expand the menu items, the menu items may be processed in a conventional menu processing manner. However, in certain embodiments, after a plurality of sub-menus are expanded, in processing of sub-menus it only needs to be clicked at the same position, thereby a switching efficiency of the sub-menus, and the menu items displayed in the expanding manner is very intuitive.

In addition, the sub-menus expanded in certain embodiments do not take extra space, but operation thereof is still efficient, and a problem of unclear instruction in the existing technology is avoided.

### Example I

One problem in the above example is that the user can not clearly know that continuous clicking may be performed to switch modes. FIG. 4 illustrates an example where, after clicking, a button may turn to be a right arrow icon which may be a visual suggestion. It shall be noted that the right arrow is merely an exemplary visual suggestion, but the present disclosure is not limited to this visual suggestion.

### Example II

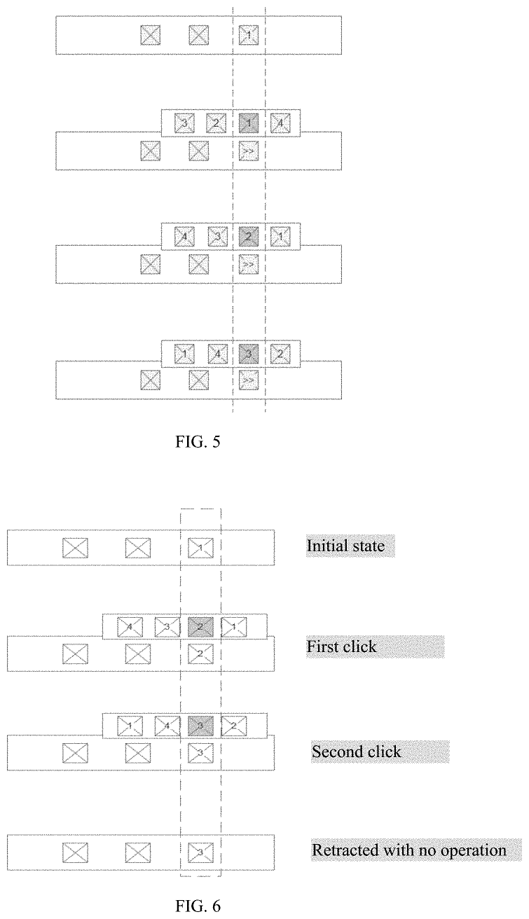

During operation it may occur that the touch screen is covered by a finger and an expanded sub-menu cannot be seen clearly. Therefore, as shown in FIG. 5, in certain embodiments, after a button icon is clicked, a visual prompt for an expanded sub-menu appears around the button. In this way, the sub-menu may not be covered by a finger during operation. In certain embodiments, the user may click sub-menus at the same position (i.e., the same button icon) to switch among the sub-menus.

### Example III

As shown in FIG. 6, compared with the previous examples, in certain embodiments, a next operation is switched to and a prompt occurs right after the first click. Compared with the previous examples, one switching operation is omitted in certain embodiments and thus efficiency is higher.

### Example IV

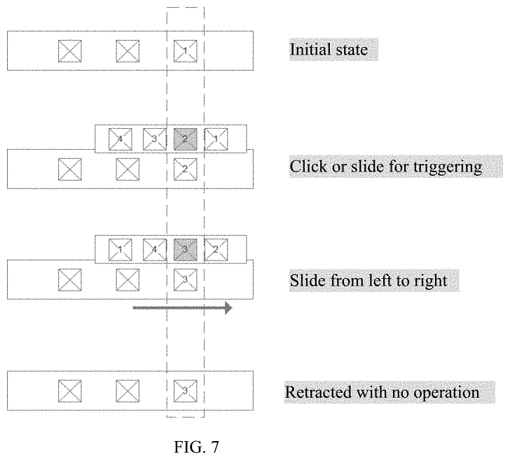

In certain embodiments, a sliding operation is introduced based on previous embodiments as shown in FIG. 7. After the sub-menus are expanded, not only may the user perform clicking and switching, a left-and-right sliding at this position may enable a high-efficient switch to a target button. That is to say, a sub-menu 2 or a sub-menu 3 or a sub-menu 4 may be switched to at once. In addition, a two-directional sliding to both left and right may be performed, so that the switching is more flexible. Alternatively, in another embodiment, a sliding operation in a corresponding direction may be performed according to an actual shape of arrangement of the menu items to perform switching.

### Example V

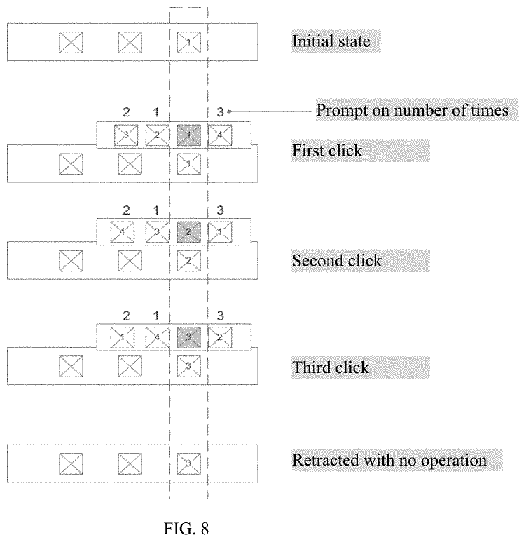

As shown in FIG. 8, in certain embodiments, a prompt on the number of times of clicking is introduced on the basis of the previous examples, and the user may know how many more clicks is required to switch to another sub-menu through the prompt. For example, in FIG. 8, apart from a current menu item, each of the other menu items display the number of times of clicking required to switch to the menu item. After each click, the number of times changes correspondingly. This embodiment may be advantageous for a highly efficient operation if there are a large number of sub-items. It shall be noted that a prompt of a number of times may not appear to each option, but may appear at some frequency, or may appear to certain important recommended sub-items.

### Example VI

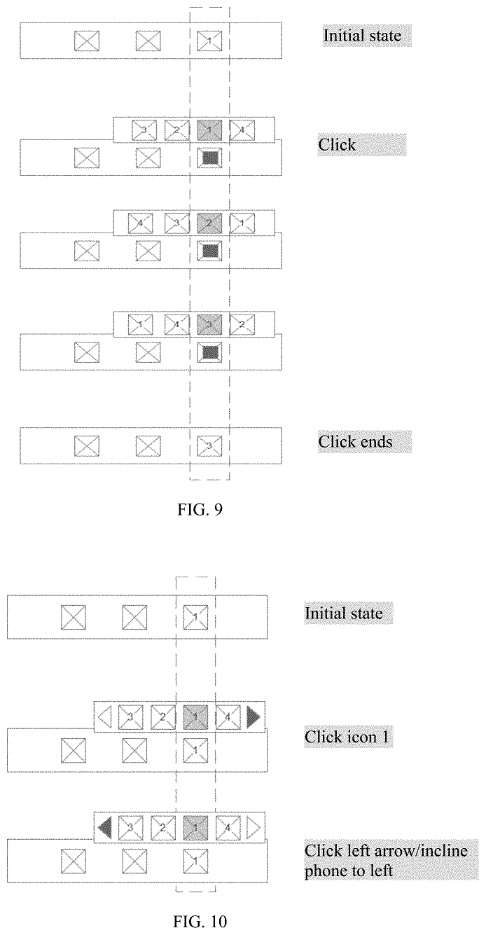

As shown in FIG. 9, in certain embodiments after a sub-menu group is expanded and an original click is performed, items 1 to 4 will be switched to successively according to a preset time table. The user may perform clicking again when an option desired by the user is reached, i.e., a switching operation on a sub-option is stopped. In certain embodiments, when sub-items 1 to 4 are being switched to, the sub-items 1 to 4 may be automatically switched to without continuous clicking.

### Example VII

In certain embodiments, a switching direction and a switching speed between items may be controlled. As shown in FIG. 10, after a first click on a button, a rectangular region is displayed over the button. The region is an expanding region for the menu items, in which expanded menu items 1 to 4 are displayed. In certain embodiments, both ends of the expanded menu items 1 to 4 are marked with right and left suggestion arrows. The user may perform clicking so as to switch directions. For example, after selecting a left direction arrow, switching will be performed to the left during a next switch. It shall be noted that the suggestion arrow is not limited to being at the two ends of the expanded menu items, but may be displayed at an appropriate position within the expanded region according to an actual layout.

In addition, it shall be noted that this embodiment is not limited to the above direction switching form. For example, the user may incline a phone in the mode, an incline of the phone can be sensed through a gyro set in the phone to control a switching direction of menu items.

Concerning speed control, in certain embodiments, a switching speed may be controlled through the gyro set in the phone. Alternatively, on a pressure screen, a control on switching speed may be performed according to pressure levels to achieve fast forwarding or fast rewinding.

In the above embodiments of the present disclosure, it may be appreciated that an operation on a button may be clicking or sliding, a switching speed among menu items may be determined by a clicking or sliding strength, and a switching direction among the menu items may be determined on a sliding direction. That is, in certain embodiments, a parameter of detecting a button operation may be a sliding direction, a clicking duration, a number of clicking times, or a combination thereof.

In addition, in a last step of “non-operated response”, a fast response may be obtained by clicking a region beside the operation region without necessity of waiting for a system response.

### Example VIII

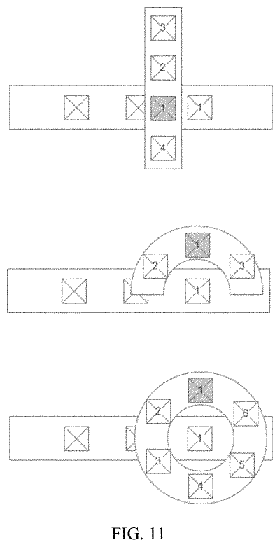

As shown in FIG. 11, in certain embodiments, different manners of expanding a sub-menu are provided. FIG. 11a shows a longitudinally expanding form suitable for a condition where there are a lot of longitudinal arrangements. FIG. 11b shows a semi-ring form of expanding sub-menus which is so flexible that different directions may be arranged according to different spaces. FIG. 11c shows a ring expanding form which may be expanded around a target and may include more sub-menu items.

### Example IX

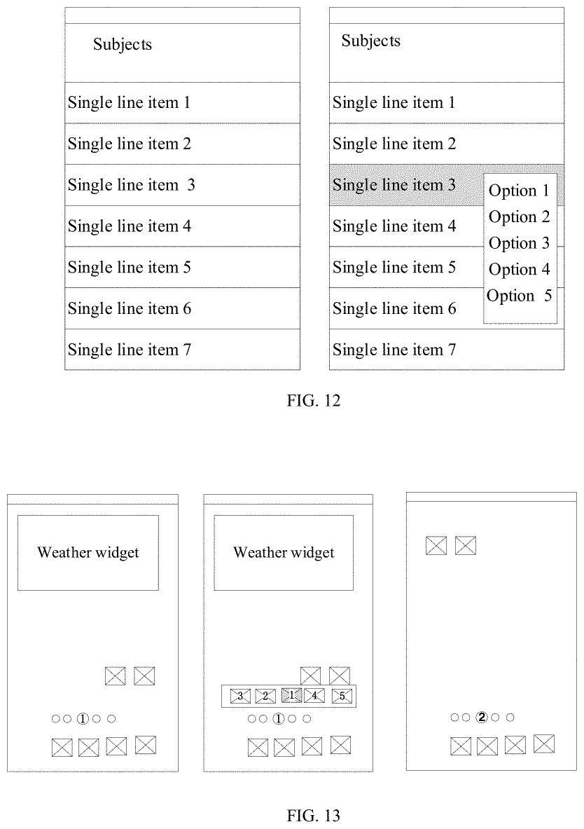

In certain embodiments, an application in a common menu is described. As shown in FIG. 12, a plurality of menu item buttons is listed. A long press on one menu item by the user will result in popping-up of a corresponding sub-menu group and each item in each sub-menu of the sub-menu group will be traversed. A following process is similar to the above embodiments.

### Example X

This example includes switching applications on a desktop according to certain embodiments. As shown in FIG. 13, the user clicks an icon button to expand a sub-menu prompt. If the user continues to click the same position of the icon button, a page 2 is switched to. Therefore, this example is advantageous for saving space and fast switching.

### Example XI

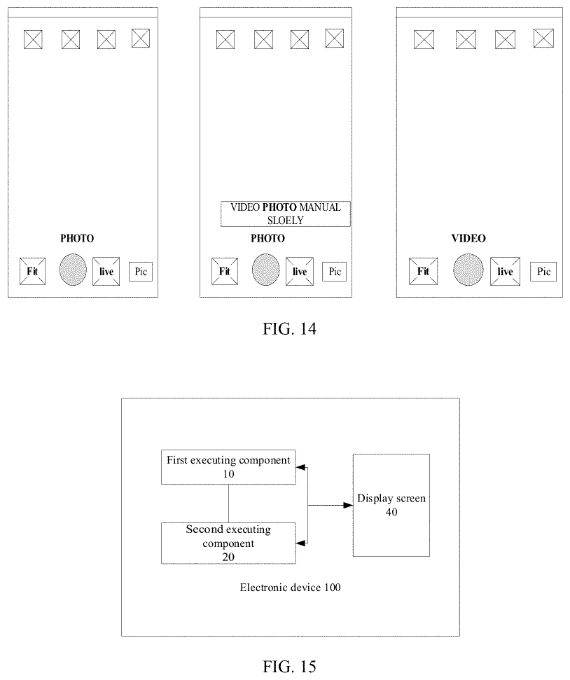

This example applies to camera mode switching according to certain embodiments. As shown in FIG. 14, the user may perform camera mode switching through clicking. After the user clicks a camera icon button PHOTO, a sub-menu group of a camera mode is expanded over the camera icon. The sub-menu group includes PANORAMA, VIDEO, PHOTO, MANUAL and SLOWLY. If the user clicks the camera icon button PHOTO again, the camera mode is switched to a video mode of VIDEO.

Those skilled in the art may understand that functional modules/unit in some or all steps, systems and devices in disclosed methods in the above text may be implemented as software, firmware, hardware and an appropriate combination thereof. In a hardware implementation, a division between the functional modules/units mentioned above may not correspond a division between physical components. For example, a physical component may have a plurality of functions, or one function or step may be implemented through a combination of a number of physical components. Some physical components or all physical components may be implemented as software implemented by a processor, for example, a central processor, a digital signal processor or a microprocessor, or as hardware, or as an integrated circuit, for example, an application specific integrated circuit. Such software may be arranged on a computer readable medium that may include a computer storage medium (or non-transitory medium) and a communication medium (or transitory medium). As is commonly known by those skilled in the art, the term of computer storage medium includes volatile and non-volatile, removable and non-removable media implemented in any method or technology used for storing information (such as a computer readable instruction, a data structure, a program module or other data). The computer storage medium may be, but is not limited to, an RAM, an ROM, an EEPROM, a flash memory or other storage technologies, a CD-ROM, a digital versatile disk (DVD) or another optical disc storage, a magnetic box, a cassette tape storage or another magnetic storage device, or any other medium that may be used to store expected information and is accessible by a computer. In addition, it is common knowledge by those skilled that a communication medium generally includes a computer readable instruction, a data structure, a program module or other data in such modulating data signals as a carrier or another transmission mechanism, and may include any information transmission medium.

An embodiment of the present disclosure further provides an electronic device configured to implement the above embodiments which will not be repeated herein. The term of “module” used in the following may implement a combination of software and/or hardware with predetermined functions. Although the devices described in the following embodiments are implemented by software, implementation by hardware or the combination of software and/or hardware is also conceivable.

FIG. 15 is a schematic diagram showing an electronic device structure according to an embodiment of the present disclosure. As shown in FIG. 15, the electronic device 100 includes a display screen 40, the user may perform an input operation on a virtual button on the display screen, and the display screen may display an operation procedure. The electronic device 100 further includes a first executing component 10 and a second executing component 20.

The first executing component 10 is configured to expand, around the menu control, multiple menu items corresponding to the menu control when a click operation on a menu control on a display screen interface is detected. The menu control on the display screen interface may be an icon button or a text button or the like, and a plurality of menu items may be expanded from an original position of a clicked button (i.e., the original button is displayed as one menu item thereof), or is displayed in a regular or irregular shape around the clicked button, for example, being expanded horizontally or longitudinally around the clicked button, or being expanded in a ring or circle around the clicked button.

The second executing component 20 is configured to carry out switching among exposed multiple menu items when a click operation and/or a sliding operation on the menu control are/is detected again. That is, the user only needs to perform a further operation, for example, clicking or sliding, on the original menu control, so as to switch among expanded menu items. It is not necessary to perform clicking or sliding in a plurality of regions, thereby operation frequency is improved.

It shall be noted that the above components may be implemented through software or hardware. The hardware may be implemented in but is not limited to the following manner: the above components are located in one processor, or the components are respectively located in different processors through a random combination.

In the above embodiments provided in the present disclosure, the control may be operated in a clearer and efficient manner, and the control may be compatible to a certain extent with a control operation manner in a related art, thereby a user's experience is promoted.

The above are embodiments of the present disclosure that are not to define the present disclosure. For those of ordinary skill, there may be various changes and variants to the present disclosure. Any amendment, equivalent substitution and improvement under the principle of the present disclosure shall fall into the protection scope of the present disclosure.

1. A control operating method, comprising:
displaying in an expanding manner, around a menu control, multiple menu items corresponding to the menu control in response to a first click operation on the menu control on a display screen; and
switching among the multiple menu items in response to one or both of a second click operation and a sliding operation on the menu control.

2. The method according to claim 1, further comprising:
selecting a menu item latest switched to, in response to one of:
not detecting an operation on the menu control within a predetermined time period, and
detecting a confirmation operation on the menu control.

3. The method according to claim 1, wherein displaying in the expanding manner, around the menu control, the multiple menu items comprises one of the following:
displaying in the expanding manner, around a position of the menu control, the multiple menu items horizontally or longitudinally, wherein one of the multiple menu items is displayed at the position of the menu control;
displaying in the expanding manner horizontally or longitudinally the multiple menu items within a predetermined region spaced from the position of the menu control;
displaying in the expanding manner the multiple menu items around the menu control, wherein a region of the multiple menu items forms a regular shape; and
displaying in the expanding manner the multiple menu items around the menu control, wherein the region of the multiple menu items forms an irregular shape.

4. The method according to claim 1, wherein switching among the multiple menu items displayed in the expanding manner when one or both of a click operation and a sliding operation on the menu control again comprises one of the following:
switching to a next menu item each time a click on the menu control is detected;
continuously switching among the multiple menu items at a switching frequency corresponding to one or both of a click strength and a click time duration of a click on the menu control;
continuously switching among the multiple menu items in response to a first click on the menu control, and stopping continuously switching in response to a second click on the menu control; and
continuously switching among the multiple menu items at a switching frequency corresponding to a sliding strength and in a switching direction corresponding to a sliding direction, in response to a sliding operation on the menu control.

5. The method according to claim 4, wherein a number is displayed on each of the multiple menu items; wherein the number indicates times required to click the menu control for switching to a respective menu item.

6. The method according to claim 4, wherein a direction prompt for switching the multiple menu items next time is displayed in a region where the multiple menu items are displayed.

7. The method according to claim 1, wherein the method further comprises: controlling a direction in which the multiple menu items are switched to according to an incline angle of the display screen.

8. The method according to claim 2, after selecting the menu item latest switched to, further comprising:
retracting the multiple menu items as expanded to an initial state.

9-16. (canceled)

17. A storage medium, storing a computer program arranged to implement a control operating method when the computer program is being executed, the control operating method comprising:
displaying in an expanding manner, around a menu control, multiple menu items corresponding to the menu control in response to a first click operation on the menu control on a display screen; and
switching among the multiple menu items in response to one or both of a second click operation and a sliding operation on the menu control.

18. An electronic device, comprising a storage and a processor, wherein the storage stores a computer program, and the processor is arranged to execute the computer program to implement a control operating method, the control operating method comprising:
displaying in an expanding manner, around a menu control, multiple menu items corresponding to the menu control in response to a first click operation on the menu control on a display screen; and
switching among the multiple menu items in response to one or both of a second click operation and a sliding operation on the menu control.

19. The electronic device according to claim 18, wherein the method further comprises:
selecting a menu item latest switched to, in response to one of:
not detecting an operation on the menu control within a predetermined time period, and
detecting a confirmation operation on the menu control.

20. The electronic device according to claim 18, wherein displaying in the expanding manner, around the menu control, the multiple menu items comprises one of the following:
displaying in the expanding manner, around a position of the menu control, the multiple menu items horizontally or longitudinally, wherein one of the multiple menu items is displayed at the position of the menu control;
displaying in the expanding manner horizontally or longitudinally the multiple menu items within a predetermined region spaced from the position of the menu control;
displaying in the expanding manner the multiple menu items around the menu control, wherein a region of the multiple menu items forms a regular shape; and
displaying in the expanding manner the multiple menu items around the menu control, wherein the region of the multiple menu items forms an irregular shape.

21. The electronic device according to claim 18, wherein switching among the multiple menu items displayed in the expanding manner when one or both of a click operation and a sliding operation on the menu control again comprises one of the following:
switching to a next menu item each time a click on the menu control is detected;
continuously switching among the multiple menu items at a switching frequency corresponding to one or both of a click strength and a click time duration of a click on the menu control;
continuously switching among the multiple menu items in response to a first click on the menu control, and stopping continuously switching in response to a second click on the menu control; and
continuously switching among the multiple menu items at a switching frequency corresponding to a sliding strength and in a switching direction corresponding to a sliding direction, in response to a sliding operation on the menu control.

22. The electronic device according to claim 21, wherein a number is displayed on each of the multiple menu items; wherein the number indicates times required to click the menu control for switching to a respective menu item.

23. The electronic device according to claim 21, wherein a direction prompt for switching the multiple menu items next time is displayed in a region where the multiple menu items are displayed.

24. The electronic device according to claim 18, wherein the method further comprises: controlling a direction in which the multiple menu items are switched to according to an incline angle of the display screen.

25. The electronic device according to claim 19, wherein after selecting the menu item latest switched to, the method further comprises:
retracting the multiple menu items as expanded to an initial state.

26. The storage medium according to claim 17, wherein the method further comprises:
selecting a menu item latest switched to, in response to one of:
not detecting an operation on the menu control within a predetermined time period, and
detecting a determination operation on the menu control.

27. The storage medium according to claim 17, wherein displaying in the expanding manner, around the menu control, multiple menu items comprises one of the following:
displaying in the expanding manner, around a position of the menu control, the multiple menu items horizontally or longitudinally, wherein the position of the menu control is displayed as one menu item;
displaying in the expanding manner horizontally or longitudinally the multiple menu items within a predetermined separated region at the position of the menu control; and
displaying in the expanding manner the multiple menu items around the menu control, the multiple menu items forming a regular or irregular shape.

28. The storage medium according to claim 17, wherein switching among the multiple menu items when one or both of a second click operation and a sliding operation on the menu control is/are detected after the first click operation comprises one of the following:
switching to a next menu item each time a click on the menu control is detected;
continuously switching among the multiple menu items at a switching frequency according to one or both of a click strength and a click time duration, in response to detecting the second click operation on the menu control;
continuously switching among the multiple menu items in response to detecting the first click operation on the menu control, and stopping continuously switching in response to detecting the second click operation on the menu control; and
continuously switching among the multiple menu items at a corresponding switching frequency according to a sliding strength and in a corresponding switching direction according to a sliding direction, in response to detecting a sliding operation on the menu control.
